(19) United States
(12) Patent Application Publication
(10) Pub. No.: US 2016/0070897 A1
(43) Pub. Date: Mar. 10, 2016

(54) TOUCH APPARATUS AND UNLOCKING METHOD THEREOF

(71) Applicant: Young Lighting Technology Inc., Hsin-Chu (TW)

(72) Inventors: Chung-Jung Lu, Hsin-Chu (TW); Po-Chun Chang, Hsin-Chu (TW)

(21) Appl. No.: 14/826,202

(22) Filed: Aug. 14, 2015

(30) Foreign Application Priority Data
Sep. 5, 2014 (TW) 103130793

(51) Int. Cl. G06F 21/32; G06K 9/00; G06F 3/041

(52) U.S. Cl. CPC G06F 21/32; G06F 3/0416; G06K 9/00087

(57) ABSTRACT

A touch apparatus and an unlocking method thereof are provided. It is determined whether to unlock the touch apparatus according to touch sensing data and biometric sensing data.

### CROSS-REFERENCE TO RELATED APPLICATION

This application claims the priority benefit of Taiwan application serial no. 103130793, filed on Sep. 5, 2014. The entirety of the above-mentioned patent application is hereby incorporated by reference herein and made a part of this specification.

### BACKGROUND OF THE INVENTION

1. Field of the Invention

The invention relates to an electronic apparatus, and particularly relates to a touch apparatus and an unlocking method thereof.

2. Description of Related Art

In modem society, smart electronic apparatuses such as smart phones and tablet personal computers (PCs) have become an indispensable part in people's daily life. The smart electronic apparatus is generally equipped with a locking mechanism for locking a screen or keys, etc. When a user unlocks the smart electronic apparatus, the user may input a predetermined password or a predetermined figure to unlock the smart electronic apparatus. However, when the user performs the unlocking operation, it is easy for others to observe unlocking information, such that the smart electronic apparatus can be unlocked by others, and information stored in the smart electronic apparatus has a risk of leakage.

Patents or patent publications related to the unlocking method of touch apparatus may include U.S. Patent Publication No. 20140132548 and U.S. Pat. No. 7,339,580, Taiwan Patent Publication No. 200823711, 201342172, 201234282 and China Patent Publication No. 102478995.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The invention is directed to a touch apparatus and an unlocking method thereof, by which a risk of leaking information stored in the touch apparatus is greatly reduced.

Other objects and advantages of the invention can be further illustrated by the technical features broadly embodied and described as follows.

In order to achieve one or a portion of or all of the objects or other objects, an embodiment of the invention provides a touch apparatus including a touch unit, a biometric sensing unit and a control unit. The touch unit is adapted to sense a touch operation of an input tool to generate touch sensing data. The biometric sensing unit is adapted to sense a biometric feature to generate biometric sensing data. The control unit is coupled to the touch unit and the biometric sensing unit, and is adapted to determine whether the touch sensing data and the biometric sensing data match predetermined unlocking data, and if the touch sensing data and the biometric sensing data match the predetermined unlocking data, the control unit unlocks the touch apparatus.

In an embodiment of the invention, the input tool is at least one finger of a user, the biometric sensing data includes a biometric sensing value between the finger of the user and a specific part of the user, the predetermined unlocking data includes a predetermined finger touch sequence and a lookup table of a plurality of finger names corresponding to a plurality of predetermined biometric values between different fingers and the specific part, the control unit includes the biometric sensing value with the lookup table to determine the fingers of the user used for performing the touch operation, and sequentially records the fingers of the user used for performing the touch operation to generate finger touch sequence data, and compares the finger touch sequence data and the predetermined finger touch sequence to determine whether the user performs the touch operation according to the predetermined finger touch sequence, where the predetermined finger touch sequence includes the finger names arranged in sequence.

In an embodiment of the invention, the specific part is a wrist.

In an embodiment of the invention, the biometric sensing value and the predetermined biometric values are capacitance values or resistance values.

In an embodiment of the invention, the touch sensing data further includes a touch sensing position, a touch sensing time and a number of sensed touches, the predetermined unlocking data further includes a predetermined touch position, a predetermined touch time and a number of predetermined touches, and the control unit further determines whether the touch sensing position, the touch sensing time and the number of sensed touches match the predetermined touch position, the predetermined touch time and the number of predetermined touches.

In an embodiment of the invention, the control unit further includes a storage unit, and the storage unit is used for storing the predetermined unlocking data.

An embodiment of the invention provides an unlocking method of a touch apparatus, which includes following steps. A touch operation of an input tool is sensed to generate touch sensing data. A biometric feature is sensed to generate biometric sensing data. It is determined whether the touch sensing data and the biometric sensing data match predetermined unlocking data. If the touch sensing data and the biometric sensing data match the predetermined unlocking data, the touch apparatus is unlocked.

In an embodiment of the invention, the input tool is at least one finger of a user, the biometric sensing data includes a biometric sensing value between the finger of the user and a specific part of the user, the predetermined unlocking data includes a predetermined finger touch sequence and a lookup table of a plurality of finger names corresponding to a plurality of predetermined biometric values between different fingers and the specific part, and the step of determining whether the touch sensing data and the biometric sensing data match the predetermined unlocking data includes following steps. The biometric sensing value is compared with the lookup table to determine the fingers of the user used for performing the touch operation, and the fingers of the user used for performing the touch operation are sequentially recorded to generate finger touch sequence data. The finger touch sequence data and the predetermined finger touch sequence are compared to determine whether the user performs the touch operation according to the predetermined finger touch sequence, where the predetermined finger touch sequence includes the finger names arranged in sequence.

In an embodiment of the invention, the specific part is a wrist.

In an embodiment of the invention, the biometric sensing value and the predetermined biometric values are capacitance values or resistance values.

In an embodiment of the invention, the touch sensing data further includes a touch sensing position, a touch sensing time and a number of sensed touches, the predetermined unlocking data further includes a predetermined touch position, a predetermined touch time and a number of predetermined touches, and the step of determining whether the touch sensing data and the biometric sensing data match the predetermined unlocking data includes following steps. It is determined whether the touch sensing position, the touch sensing time and the number of sensed touches match the predetermined touch position, the predetermined touch time and the number of predetermined touches.

According to the above descriptions, in the embodiment of the invention, it is determined whether to unlock the touch apparatus according to the touch sensing data and the biometric sensing data, so as to greatly decrease the risk of leaking the information of the touch apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block schematic diagram of a touch apparatus according to an embodiment of the invention.

FIG. 2 is a schematic diagram of a hand of a user used for performing a touch operation according to an embodiment of the invention.

FIG. 3 is a flowchart illustrating an unlocking method of a touch apparatus according to an embodiment of the invention.

FIG. 4 is a flowchart illustrating an unlocking method of a touch apparatus according to another embodiment of the invention.

FIG. 5 is a flowchart illustrating an unlocking method of a touch apparatus according to another embodiment of the invention.

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

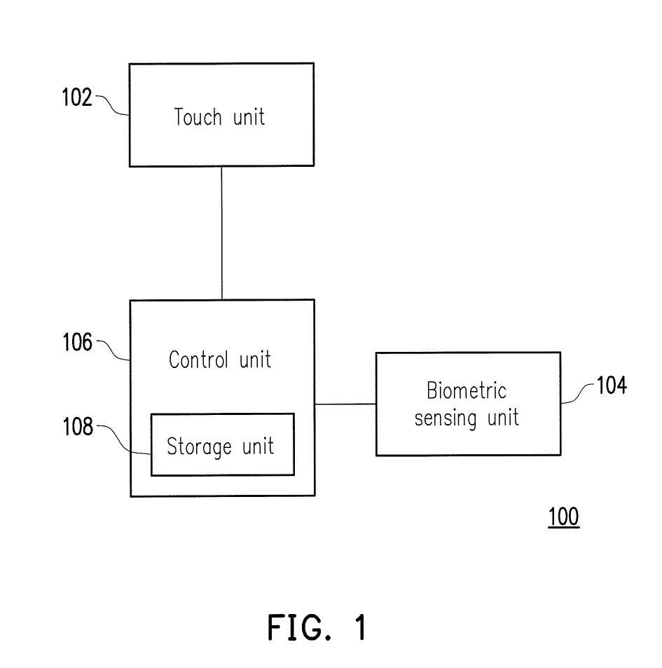

FIG. 1 is a block schematic diagram of a touch apparatus according to an embodiment of the invention. The touch apparatus 100 is configured to an electronic apparatus. The electronic apparatus, for example, is a portable device, such as a smart phone, a tablet computer, or a notebook computer, though the invention is not limited thereto. Referring to FIG. 1, the touch apparatus 100 includes a touch unit 102, a biometric sensing unit 104 and a control unit 106. The control unit 106 is coupled to the touch unit 102 and the biometric sensing unit 104. The control unit 106, for example, includes a processor, a micro control unit, a processing IC circuit, or a chipset, though the invention is not limited thereto. The touch unit 102 is adapted to sense a touch operation of an input tool to generate touch sensing data. The biometric sensing unit 104 is adapted to sense a biometric feature to generate biometric sensing data. Moreover, the control unit 106 is adapted to determine whether the touch sensing data and the biometric sensing data match predetermined unlocking data, and if the touch sensing data and the biometric sensing data match the predetermined unlocking data, the control unit 106 unlocks the touch apparatus 100.

As described above, by determining whether the touch sensing data and the biometric sensing data match the predetermined unlocking data, it is determined whether to unlock the touch apparatus 100. Since the biometric feature of each user is different, even if unlocking information is known by others, the touch apparatus 100 is not easy to be unlocked, such that security of the touch apparatus 100 is greatly improved, and the risk of leaking information of the touch apparatus 100 is decreased.

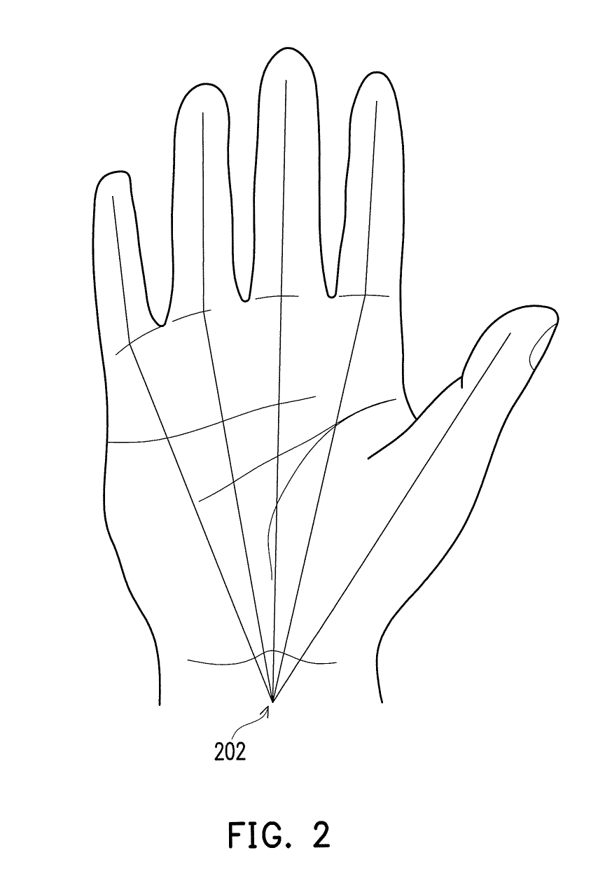

Further, the control unit 106 may include a storage unit 108 (for example, is a memory), which is used for storing the aforementioned predetermined unlocking data. Moreover, the input tool is, for example, at least one finger of the user, though the invention is not limited thereto. The biometric sensing unit 104 is, for example, a charge-coupled device (CCD), a complementary metal oxide semiconductor (CMOS), a fingerprint sensor, or other sensors suitable for sensing a biometric feature, though the invention is not limited thereto. In the embodiment, the biometric sensing unit 104 may sense a biometric sensing value between the finger of the user used for performing the touch operation and a specific part of the user, and takes the same as the aforementioned biometric sensing data. The biometric sensing value is, for example, a resistance value or a capacitance value of human body, and the specific part of the user is, for example, a wrist of the user. FIG. 2 is a schematic diagram of a hand of the user used for performing the touch operation according to an embodiment of the invention. As shown in FIG. 2, since a thickness and a length of each finger and a distance between each finger and a wrist 202 are different, the resistance value or the capacitance value between the part of each finger used for performing the touch operation (for example, a fingertip) and the wrist 202 is different.

The aforementioned predetermined unlocking data may include a predetermined finger touch sequence and a lookup table of a plurality of finger names corresponding to a plurality of predetermined biometric values between different fingers and the specific part, and the control unit 106 compares the biometric sensing value sensed by the biometric sensing unit 104 with the lookup table to determine the finger of the user used for performing the touch operation. Namely, the control unit 106 can compare the biometric sensing value of the corresponding finger with the predetermined biometric value in the lookup table to identify a finger name (for example, a thumb or a forefinger) of the user, and since the user uses the finger to perform the touch operation, the biometric value detected by the biometric sensing unit 104 is varied (for example, the resistance value or the capacitance value is changed), such that the finger of the user used for performing the touch operation can be determined. Moreover, the control unit 106 sequentially records the fingers of the user used for performing the touch operation to generate finger touch sequence data, and compares the finger touch sequence data and the predetermined finger touch sequence to determine whether the user performs the touch operation according to the predetermined finger touch sequence, where the predetermined finger touch sequence includes the finger names arranged in sequence. If the control unit 106 determines that the user performs the touch operation according to the predetermined finger touch sequence, the control unit 106 unlocks the touch apparatus 100.

Moreover, in other embodiments, the touch sensing data further includes a touch sensing position, a touch sensing time and a number of sensed touches, the predetermined unlocking data further includes a predetermined touch position, a predetermined touch time and a number of predetermined touches. Besides determining whether the user performs the touch operation according to the predetermined finger touch sequence, the control unit 106 further determines whether the touch sensing position, the touch sensing time and the number of sensed touches match the predetermined touch position, the predetermined touch time and the number of predetermined touches according to a sensing result of the touch unit 102, and unlocks the touch apparatus 100 only when the touch sensing position, the touch sensing time and the number of sensed touches match the predetermined touch position, the predetermined touch time and the number of predetermined touches. In this way, in order to unlock the touch apparatus 100, besides that the finger touch sequence of the user is required to be correct, the touch sensing position, the touch sensing time and the number of sensed touches are also required to be correct, so as to further ensure information security of the touch apparatus 100.

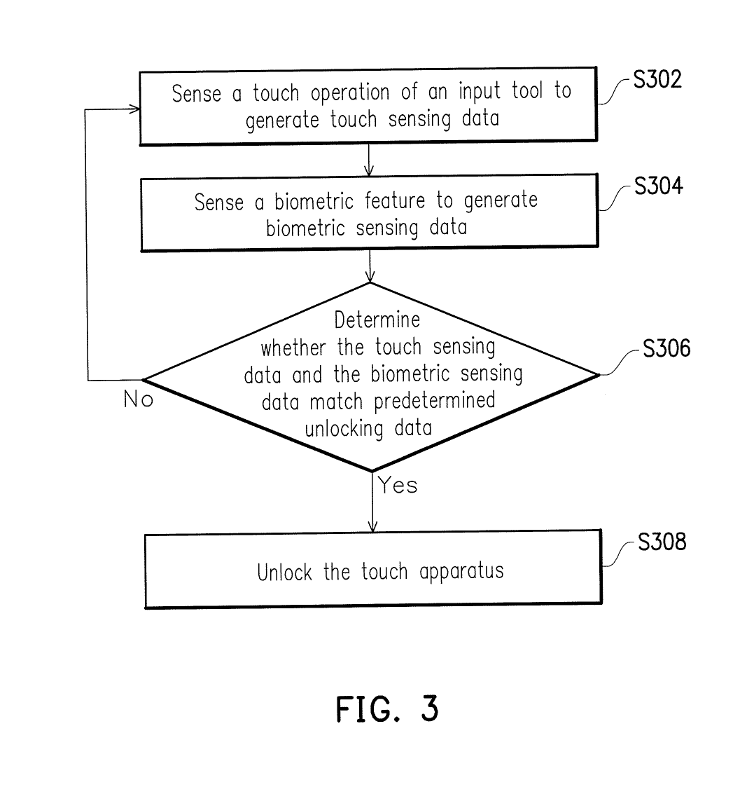

FIG. 3 is a flowchart illustrating an unlocking method of a touch apparatus according to an embodiment of the invention. Referring to FIG. 3, according to the aforementioned embodiment, it is known that the unlocking method of the touch apparatus includes following steps. First, a touch operation of an input tool is sensed to generate touch sensing data (step S302), where the input tool is, for example, at least one finger of the user, though the invention is not limited thereto. Then, a biometric feature is sensed to generate biometric sensing data (step S304). It is determined whether the touch sensing data and the biometric sensing data match predetermined unlocking data (step S306). If the touch sensing data and the biometric sensing data match predetermined unlocking data, the touch apparatus is unlocked (step S308).

Comparatively, if the touch sensing data and the biometric sensing data do not match the predetermined unlocking data, the flow returns to the step S302 to continually sense the touch operation of the input tool.

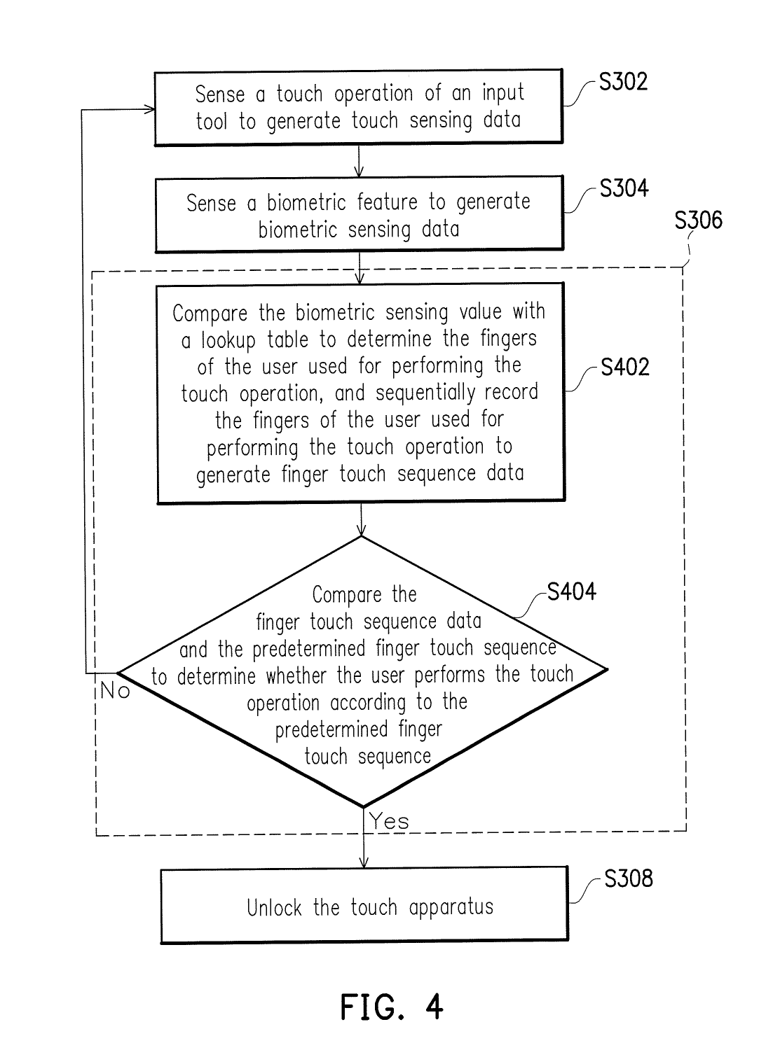

FIG. 4 is a flowchart illustrating an unlocking method of a touch apparatus according to an embodiment of the invention. Referring to FIG. 4, the biometric sensing data includes a biometric sensing value between the finger of the user and a specific part of the user, where the specific part of the user is, for example, a wrist of the user, though the invention is not limited thereto. The predetermined unlocking data may include a predetermined finger touch sequence and a lookup table of a plurality of finger names corresponding to a plurality of predetermined biometric values between different fingers and the specific part, where the biometric sensing value and the predetermined biometric values are, for example, capacitance values or resistance values. In the embodiment, the step S306 may further includes a step S402 and a step S404, i.e. after the biometric feature is sensed to generate biometric sensing data (the step S304), the biometric sensing value is first compared with the lookup table to determine the fingers of the user used for performing the touch operation, and the fingers of the user used for performing the touch operation are sequentially recorded to generate finger touch sequence data (step S402), and the finger touch sequence data and the predetermined finger touch sequence are compared to determine whether the user performs the touch operation according to the predetermined finger touch sequence (step S404), where the predetermined finger touch sequence includes the finger names arranged in sequence. If the user performs the touch operation according to the predetermined finger touch sequence, the step S308 is executed to unlock the touch apparatus. Comparatively, if the user does not perform the touch operation according to the predetermined finger touch sequence, the flow returns to the step S302 to continually sense the touch operation of the input tool.

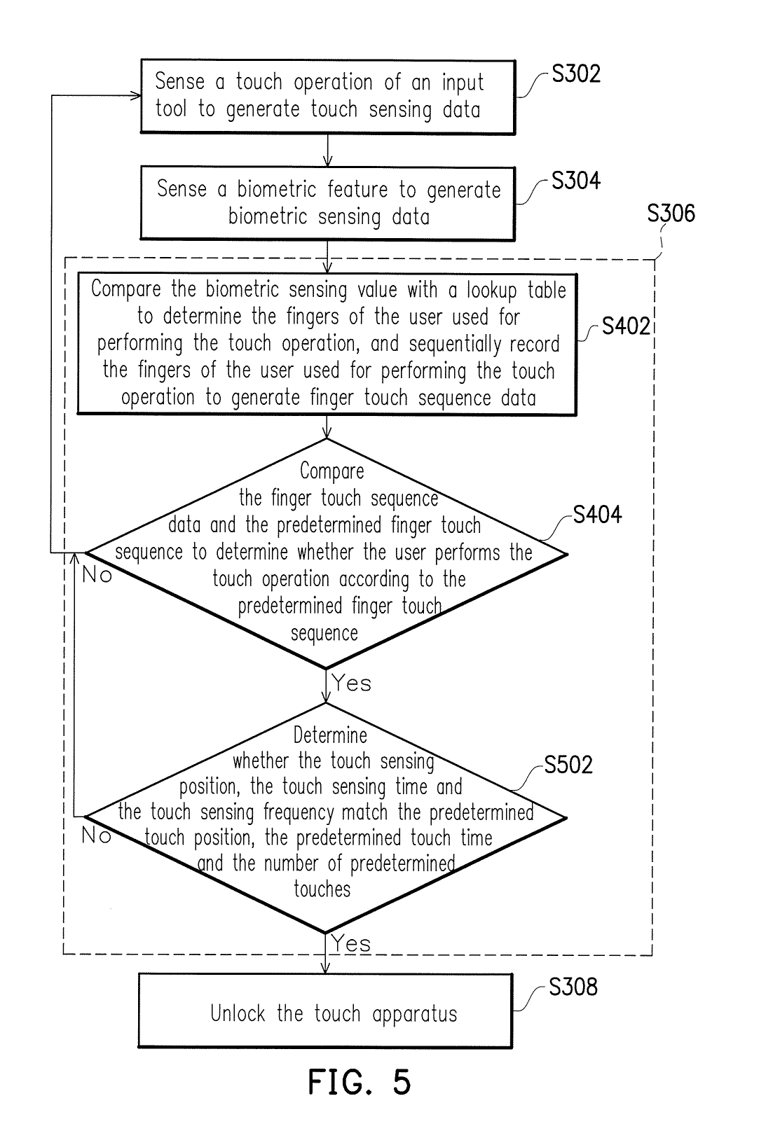

FIG. 5 is a flowchart illustrating an unlocking method of a touch apparatus according to an embodiment of the invention. Referring to FIG. 5, the touch sensing data may include a touch sensing position, a touch sensing time and a number of sensed touches, the predetermined unlocking data may further include a predetermined touch position, a predetermined touch time and a number of predetermined touches. In the embodiment, the step S306 may further include a step S502, i.e. after the step S404 of determining whether the user performs the touch operation according to the predetermined finger touch sequence, it is further determined whether the touch sensing position, the touch sensing time and the number of sensed touches match the predetermined touch position, the predetermined touch time and the number of predetermined touches. Only when the touch sensing position, the touch sensing time and the number of sensed touches match the predetermined touch position, the predetermined touch time and the number of predetermined touches, the step S308 is executed to unlock the touch apparatus. Comparatively, when the touch sensing position, the touch sensing time and the number of sensed touches do not match the predetermined touch position, the predetermined touch time and the number of predetermined touches, the flow returns to the step S302 to continually sense the touch operation of the input tool.

The embodiments of the invention have at least one of the following advantages. In the embodiments of the invention, it is determined whether to unlock the touch apparatus according to the touch sensing data and the biometric sensing data, so as to greatly decrease the risk of leaking the information of the touch apparatus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch apparatus, comprising:
a touch unit, adapted to sense a touch operation of an input tool to generate touch sensing data;
a biometric sensing unit, adapted to sense a biometric feature to generate biometric sensing data; and
a control unit, coupled to the touch unit and the biometric sensing unit, and adapted to determine whether the touch sensing data and the biometric sensing data match predetermined unlocking data, wherein the control unit unlocks the touch apparatus when the touch sensing data and the biometric sensing data match the predetermined unlocking data.

2. The touch apparatus as claimed in claim 1, wherein the input tool is at least one finger of a user, the biometric sensing data comprises a biometric sensing value between the finger of the user and a specific part of the user, the predetermined unlocking data comprises a predetermined finger touch sequence and a lookup table of a plurality of finger names corresponding to a plurality of predetermined biometric values between different fingers and the specific part, the control unit compares the biometric sensing value with the lookup table to determine the fingers of the user used for performing the touch operation, and sequentially records the fingers of the user used for performing the touch operation to generate finger touch sequence data, and compares the finger touch sequence data and the predetermined finger touch sequence to determine whether the user performs the touch operation according to the predetermined finger touch sequence, wherein the predetermined finger touch sequence comprises the finger names arranged in sequence.

3. The touch apparatus as claimed in claim 2, wherein the specific part is a wrist.

4. The touch apparatus as claimed in claim 2, wherein the biometric sensing value and the predetermined biometric values are capacitance values or resistance values.

5. The touch apparatus as claimed in claim 2, wherein the touch sensing data further comprises a touch sensing position, a touch sensing time and a number of sensed touches, the predetermined unlocking data further comprises a predetermined touch position, a predetermined touch time and a number of predetermined touch, and the control unit further determines whether the touch sensing position, the touch sensing time and the number of sensed touches match the predetermined touch position, the predetermined touch time and the number of predetermined touches.

6. The touch apparatus as claimed in claim 1, wherein the control unit further comprises a storage unit, and the storage unit is used for storing the predetermined unlocking data.

7. An unlocking method of a touch apparatus, comprising:
sensing a touch operation of an input tool to generate touch sensing data;
sensing a biometric feature to generate biometric sensing data;
determining whether the touch sensing data and the biometric sensing data match predetermined unlocking data; and
unlocking the touch apparatus when the touch sensing data and the biometric sensing data match the predetermined unlocking data.

8. The unlocking method of the touch apparatus as claimed in claim 7, wherein the input tool is at least one finger of a user, the biometric sensing data comprises a biometric sensing value between the finger of the user and a specific part of the user, the predetermined unlocking data comprises a predetermined finger touch sequence and a lookup table of a plurality of finger names corresponding to a plurality of predetermined biometric values between different fingers and the specific part, and the step of determining whether the touch sensing data and the biometric sensing data match the predetermined unlocking data comprises:
comparing the biometric sensing value with the lookup table to determine the fingers of the user used for performing the touch operation, and sequentially recording the fingers of the user used for performing the touch operation to generate finger touch sequence data; and
comparing the finger touch sequence data and the predetermined finger touch sequence to determine whether the user performs the touch operation according to the predetermined finger touch sequence, wherein the predetermined finger touch sequence comprises the finger names arranged in sequence.

9. The unlocking method of the touch apparatus as claimed in claim 8, wherein the specific part is a wrist.

10. The unlocking method of the touch apparatus as claimed in claim 8, wherein the biometric sensing value and the predetermined biometric values are capacitance values or resistance values.

11. The unlocking method of the touch apparatus as claimed in claim 8, wherein the touch sensing data further comprises a touch sensing position, a touch sensing time and a number of sensed touches, the predetermined unlocking data further comprises a predetermined touch position, a predetermined touch time and a number of predetermined touches, and the step of determining whether the touch sensing data and the biometric sensing data match the predetermined unlocking data comprises:
determining whether the touch sensing position, the touch sensing time and the number of sensed touches match the predetermined touch position, the predetermined touch time and the number of predetermined touches.
